(19) United States
(12) Patent Application Publication
(10) Pub. No.: US 2026/0092643 A1
(43) Pub. Date: Apr. 2, 2026

(54) DRIVE DEVICE FOR AN ELECTRIC BICYCLE AND ASSEMBLY FOR A DRIVE DEVICE

(71) Applicant: Porsche eBike Performance GmbH, Ottobrunn (DE)

(72) Inventors: Jörg Aniol, Leonberg (DE); Harald Hobohm, Maulbronn (DE); Andreas Hoppe, Munich (DE)

(21) Appl. No.: 19/339,033

(22) Filed: Sep. 24, 2025

(30) Foreign Application Priority Data
Sep. 30, 2024 (DE) 10 2024 128 280.0

(51) Int. Cl. F16H 57/08; B62M 6/55; F16C 19/06; F16H 37/04

(52) U.S. Cl. CPC F16H 57/082; B62M 6/55; F16C 19/06; F16H 37/041; F16C 2361/61

(57) ABSTRACT

A drive device includes a planetary gearbox with a planet carrier. The planet carrier is mounted rotatably about a rotational axis via a radial bearing and an axial bearing. An assembly is for a drive device of an electric bicycle. The assembly includes a planet carrier for a planetary gearbox and a radial bearing and an axial bearing for mounting the planet carrier rotatably about a rotational axis.

### CROSS-REFERENCE TO RELATED APPLICATIONS

This application claims priority of German patent application no. 10 2024 128 280.0, filed Sep. 30, 2025, the entire content of which is incorporated herein by reference.

### TECHNICAL FIELD

A drive device for an electric bicycle is described. In addition, an assembly for a drive device of an electric bicycle, a method for assembling a drive device of an electric bicycle, and an electric bicycle are described.

### BACKGROUND

Bicycles are a cost-effective, easy-to-use, and emission-free means of transportation. They have also become popular as sports and fitness equipment, and certain types have proven to be particularly suitable for various athletic applications.

In recent years, enthusiasm for electric bicycles (especially so-called “pedelecs”) has been growing, despite their high weight and price compared to conventional bicycles. In the case of electric bicycles, it is important to provide a reliable drive device.

### SUMMARY

It is an object of the disclosure to specify a drive device for an electric bicycle that contributes to an efficient and low-wear operation of the electric bicycle. Further tasks to be solved are to specify an assembly for such a drive device, a method for assembling such a drive device, and an electric bicycle with such a drive device.

First, the drive device for an electric bicycle is specified.

In at least one embodiment, the drive device includes a planetary gearbox with a planet carrier, wherein the planet carrier is mounted rotatably about a rotational axis via a radial bearing and an axial bearing.

The present disclosure is based, inter alia, on the realization that, in addition to radial forces, axial forces can also act on the planet carrier in the drive device. By combining a radial bearing and an axial bearing for mounting the planet carrier, all acting forces can be effectively absorbed, thereby minimizing wear on the drive device. This also results in good power transmission and low noise levels.

In the drive device, the planet carrier is mounted so that it can rotate about a rotational axis. This means, in particular, that the planet carrier can rotate relative to a housing of the drive device. Unless otherwise specified, directions parallel to the rotational axis of the planet carrier are referred to here and in the following as “axial directions” or simply as “axial. ” Furthermore, unless otherwise indicated, the directional terms “radial” and “azimuthal” refer to this rotational axis. The planet carrier is, for example, rotationally symmetrical with respect to its rotational axis.

The planet carrier is mounted rotatably via a radial bearing and an axial bearing. The radial bearing and the axial bearing are roller bearings in particular. For example, only the one radial bearing and the one axial bearing are used for the rotary mounting of the planet carrier. The radial bearing absorbs forces perpendicular to the rotational axis of the planet carrier, that is, radially acting forces, whereas the axial bearing absorbs forces parallel to the rotational axis, that is, axially acting forces. The radial bearing is supported by the planet carrier, for example. The radial bearing and the axial bearing are arranged in particular at axially opposite areas of the planet carrier, that is, the planet carrier is arranged in sections in the axial direction between the radial bearing and the axial bearing.

In addition to the planet carrier, the planetary gearbox includes a planet gear, which is rotatably mounted on the planet carrier, as well as a ring gear and a sun gear. The planet gear meshes with the sun gear and the ring gear. The ring gear can be connected to the housing in a rotationally fixed manner, meaning that it does not rotate during operation. The sun gear rotates, for example, about the same rotational axis as the planet carrier. The rotational axis of the planet gear runs parallel or essentially parallel to the rotational axis of the planet carrier. During operation, the rotational axis of the planet gear rotates about the rotational axis of the planet carrier. The planet carrier can be made of metal. The planet gear can be made partly of plastic.

For example, the planet gear is mounted rotatably relative to the planet carrier via a needle bearing. The use of a needle bearing is useful for counteracting tilting of the planet gear relative to the planet carrier.

For the rotary mounting of the planet gear on the planet carrier, the planet gear may have a bolt or pin that is inserted through or into a recess in the planet carrier. Alternatively, the planet carrier may have a bolt or bushing that is inserted through a hole in the planet gear.

The planetary gearbox may have two or more, for example three, planet gears. The planet gears are then all rotatably mounted on the planet carrier. In particular, each of the planet gears is rotatably mounted on the planet carrier via a needle bearing. All features disclosed in connection with one planet gear are also disclosed for all further planet gears of the planetary gearbox.

According to at least one embodiment, the axial bearing has elongated rolling elements. The longitudinal axes of the rolling elements run, for example, in a radial direction. The rolling elements of the axial bearing can be cylindrical or conical. The axial bearing can be a needle bearing. The radial bearing is, for example, a ball bearing.

According to at least one embodiment, the axial bearing is arranged in the radial direction on the outer circumference of the planet carrier. This means that the axial bearing is arranged as far away as possible from the rotational axis of the planet carrier on the planet carrier. As a result, the support width of the axial bearing is particularly large, and axial forces can be absorbed particularly well.

According to at least one embodiment, the axial bearing and the planet gear of the planetary gearbox are at least partially at the same height in the radial direction. In other words, there is a region of the axial bearing that is spaced just as far from the rotational axis of the planet carrier in the radial direction as a region of the at least one planet gear. In particular, the axial bearing is further away from the rotational axis of the planet carrier in the radial direction than the rotational axis of the planet gear. Alternatively or additionally, the axial bearing and the ring gear of the planetary gearbox are located at the same height in the radial direction, at least in sections.

According to at least one embodiment, the axial clearance of the planet carrier in the drive device is at most 0.3 mm or at most 0.2 mm or at most 0.1 mm. This means that during operation, the planet carrier can be displaced in a direction parallel to the rotational axis by at most 0.3 mm or at most 0.2 mm or at most 0.1 mm. Such a small axial clearance of the planet carrier also keeps the maximum angle by which the planet carrier can tilt during operation small. Such a small axial clearance can be achieved in particular by a small tolerance chain in the axial direction. Axial movement of the planet carrier is limited, for example, by stops provided on both sides of the planet carrier in the axial direction.

According to at least one embodiment, a thrust washer of the axial bearing is directly opposite a support element of the drive device in the axial direction. The support element forms, for example, one of the two stops mentioned above. For example, the support element is a section of the housing or is fixed with respect to the housing, that is, arranged immovably relative to the housing. The support element can in particular be a radially extending section of the housing. The thrust washers are the washers of the axial bearing on which the rolling elements of the axial bearing roll.

The fact that two elements are opposite each other in the axial direction means that, when viewed parallel to the rotational axis of the planet carrier, one element at least partially covers the other element. In other words, the two elements are at the same height in both the radial and azimuthal directions, at least in sections. The fact that the elements are directly opposite each other means that, apart from a gap filled with air or lubricant at most, no other element, in particular no other solid body of the drive device, is arranged between them.

According to at least one embodiment, a further thrust washer of the axial bearing is directly opposite the planet carrier in the axial direction. In particular, the planet carrier is spaced apart from the support element in the axial direction by the axial bearing.

According to at least one embodiment, a ring of the radial bearing is directly opposite a further support element of the drive device in the axial direction. The further support element forms the other of the two stops mentioned above. In particular, the further support element is a section of the housing or is fixed with respect to the housing, that is, arranged immovably relative to the housing. The further support element is, for example, a radially extending housing section. The ring is, in particular, the outer ring of the radial bearing. The rolling elements of the radial bearing run on the ring.

According to at least one embodiment, a further ring of the radial bearing is directly opposite the planet carrier in the axial direction. The other ring is, in particular, the inner ring of the radial bearing. The other ring may be spaced apart from the planet carrier by an O-ring. The rolling elements of the radial bearing run on the further ring.

According to at least one embodiment, some or all of the aforementioned elements directly opposite each other adjoin each other. At least, the sum of the axial distances between the aforementioned directly opposite elements is at most 0.1 mm or at most 0.05 mm or at most 0.02 mm. Because only the axial bearing and the radial bearing are arranged axially between the planet carrier and the two support elements, the tolerance chain in the axial direction is kept small, thereby achieving a small axial play of the planet carrier.

According to at least one embodiment, the radial bearing is coupled both directly to the planet carrier and directly to the housing of the drive device. In particular, the radial bearing adjoins the housing and the planet carrier in the radial direction. For example, the outer ring of the radial bearing adjoins the housing in the radial direction, and the inner ring of the radial bearing adjoins the planet carrier in the radial direction. In the area where the radial bearing adjoins the housing in the radial direction, the housing is formed with a single wall, for example, and its surface opposite the radial bearing forms an outer surface of the drive device.

Because the radial bearing adjoins both the housing and the planet carrier in the radial direction, the tolerance chain in the radial direction is also kept small, which also keeps the maximum tilt angle of the planet carrier small.

According to at least one embodiment, the planet gear is arranged axially between the axial bearing and the radial bearing.

According to at least one embodiment, the radial bearing is at least partially at the same height as the planet gear in the radial direction. For example, the radial bearing protrudes radially away from the rotational axis of the planet carrier beyond the planet gear. In particular, the radial bearing is spaced further away from the rotational axis of the planet carrier in the radial direction than the rotational axis of the planet gear. Alternatively or additionally, the radial bearing may be located at least in sections at the same height as the ring gear of the planetary gearbox in the radial direction.

According to at least one embodiment, the inner diameter of the radial bearing is larger than the inner diameter of the axial bearing. For example, the inner diameter of the radial bearing is at least 4 cm or at least 5 cm.

By positioning the radial bearing far away from the rotational axis, the planet carrier can be precisely aligned and held stably in its radial position during operation. A large radial bearing also helps to counteract tilting.

According to at least one embodiment, the drive device further includes an electric motor and an output. The electric motor is coupled to the output via the planetary gearbox to transmit torque from the electric motor to the output.

In other words, the planetary gearbox is connected between the electric motor and the output. The planetary gearbox is specifically configured to increase the torque delivered by the electric motor. For example, the planetary gearbox is arranged axially between the electric motor and the output.

The electric motor includes a stator and a rotor. For example, the electric motor is an internal rotor motor.

The output is the component of the drive device from which torque is diverted from the drive device. For example, the output includes an output shaft. The output shaft may be a hollow shaft. For example, a pedal axle of the drive device extends through the output shaft. The output shaft may be connected in a rotationally fixed manner to a chainring or a chainring spider. Alternatively or additionally, the output shaft has an interface for coupling with a chainring or a chainring spider.

According to at least one embodiment, the drive device further includes a bevel gear stage. In particular, the bevel gear stage couples the planetary gearbox with the output. In other words, the bevel gear stage is connected between the planetary gearbox and the output. The bevel gear stage is, for example, configured to further increase the torque delivered by the planetary gearbox. The bevel gear stage may be a 90° bevel gear stage. The planetary gearbox is, for example, arranged axially between the electric motor and the bevel gear stage.

Due to the coupling of the planetary gearbox with the bevel gear stage, a high tilting moment and large axial forces can act on the planet carrier during operation of the drive device. The forces acting are well supported by the axial bearing and the radial bearing.

According to at least one embodiment, the bevel gear stage is coupled to the planet carrier without an intermediate gear stage. In other words, the torque delivered by the planetary gearbox is the torque fed into the bevel gear stage. For example, a component of the planetary gearbox is coupled to a bevel gear of the bevel gear stage in a rotationally fixed manner.

According to at least one embodiment, the radial bearing is arranged axially between the axial bearing and a second bevel gear of the bevel gear stage. In particular, the radial bearing is arranged in the axial direction at least in sections at the height of the planet carrier.

According to at least one embodiment, the support width of the axial bearing is greater than the axial distance of the radial bearing to the interface of the bevel gears of the bevel gear stage. This serves in particular to keep the axial forces absorbed by the axial bearing as low as possible. On the other hand, the tilting point of the planet carrier is located in the axial direction near the radial bearing. Due to a smaller axial distance between the radial bearing and the intersection of the bevel gears in relation to the support width, the lever for the force causing the tilting can be kept relatively small. The interface of the bevel gears is understood here to be the area in which the toothing of the two bevel gears mesh with each other.

According to at least one embodiment, the planet carrier is coupled in a rotationally fixed manner to a first bevel gear of the bevel gear stage. This means that during operation, the first bevel gear rotates together with the planet carrier around the rotational axis of the planet carrier at the same rotational speed and in the same direction. In particular, the first bevel gear is connected directly to the planet carrier, for example via a form-fit and/or force-fit connection. Alternatively, the planet carrier and the first bevel gear could also be formed integrally with one another. The first bevel gear is, for example, a bevel pinion.

Due to the coupling of the first bevel gear with the planet carrier and the stable mounting of the planet carrier via the axial bearing and the radial bearing, the first bevel gear is also mounted in a particularly positionally stable manner, which is advantageous for high power transmission.

According to at least one embodiment, the bevel gear stage includes the above-mentioned second bevel gear. The second bevel gear meshes with the first bevel gear. For example, the second bevel gear is coupled to the output without an intermediate gear stage. A rotational axis of the second bevel gear runs obliquely or perpendicularly to the rotational axis of the planet carrier or the first bevel gear. The rotational axis of the output is, for example, parallel or identical to the rotational axis of the second bevel gear. In particular, the rotational axis of the planet carrier lies in a plane that is perpendicular to the rotational axis of the output. The second bevel gear is, for example, a ring gear. The drive device is, for example, an orthogonal drive.

According to at least one embodiment, the second bevel gear is coupled to the output via a freewheel. For example, the freewheel couples the second bevel gear to the output shaft of the output.

According to at least one embodiment, the output shaft of the output is coupled to a pedal shaft of the drive device via a freewheel.

The freewheel is, for example, a toothed disc freewheel. In particular, the pedal shaft passes through the output shaft, which is formed as a hollow shaft.

According to at least one embodiment, the pedal shaft extends obliquely or perpendicularly to the rotational axis of the planet carrier. In other words, a rotational axis of the pedal shaft is inclined or perpendicular to the rotational axis of the planet carrier. For example, the angle between the pedal shaft or the rotational axis of the pedal shaft and the rotational axis of the planet carrier is between 80° and 100° inclusive.

Next, the electric bicycle is described. The electric bicycle includes a drive device according to one of the embodiments described herein.

Next, the assembly for a drive device of an electric bicycle and the method for assembling a drive device are specified. In particular, the assembly is configured for assembling a drive device according to one of the embodiments described herein. In this respect, all features disclosed in connection with the drive device are also disclosed for the assembly and the method, and vice versa.

In at least one embodiment, the assembly for a drive device of an electric bicycle includes a planet carrier for a planetary gearbox as well as a radial bearing and an axial bearing for mounting the planet carrier rotatably about a rotational axis.

In addition to the planet carrier, the radial bearing, and the axial bearing, the assembly may include a housing part, for example a bottom bracket housing. The planet carrier is mounted rotatably relative to this housing part. The housing part of the assembly can be connected to one or more additional housing parts of one or more additional assemblies to form a housing for the drive device. Furthermore, the assembly can have at least one planetary gear and one ring gear. In addition, the assembly can have a first bevel gear connected to the planet carrier in a rotationally fixed manner for a bevel gear stage. In addition, the assembly may include a pedal shaft.

The further assembly includes, for example, an electric motor with a stator, a rotor, and a motor shaft. The further assembly may include the support element for the thrust washer of the axial bearing. Furthermore, the further assembly includes a housing part, for example a motor housing.

Yet another assembly includes, for example, the output and the second bevel gear coupled thereto for the bevel gear stage.

Furthermore, the yet another assembly includes a housing part, for example a cover.

In at least one embodiment, the assembly and the further assembly are connected to each other for the assembling of the drive device, in particular by connecting their housing parts to each other. In this process, the support element of the further assembly, which is formed, for example, by the further housing part of the further assembly, is arranged axially directly opposite the thrust washer of the axial bearing. The motor shaft can be inserted through the planet carrier during the assembling.

According to at least one embodiment, the assembly is connected to the yet another assembly in the method. The housing parts of the assembly and the yet another assembly can be screwed together. In addition, the bevel gears of the assembly and the yet another assembly can be brought into engagement. Furthermore, for example, the pedal shaft of the assembly is pushed through the output shaft of the yet another assembly.

Hereinafter, the drive device described herein, the assembly described herein, the method for assembling a drive device described herein, and the electric bicycle described herein are explained in more detail with reference to drawings on the basis of embodiments. The same reference signs indicate the same elements in the individual figures. Insofar as elements or components in the various figures are identical in function, their description is not repeated for each of the following figures. For reasons of clarity, elements may not be provided with respective reference signs in all figures.

### BRIEF DESCRIPTION OF DRAWINGS

The invention will now be described with reference to the drawings wherein:

FIG. 1 shows an embodiment of the electric bicycle;

FIG. 2 shows an embodiment of the drive device;

FIG. 3 shows another embodiment of the drive device;

FIG. 4 shows an embodiment of the assembly;

FIG. 5 shows an embodiment of the further assembly;

FIG. 6 shows a position in an embodiment of the assembly method;

FIG. 7 shows an embodiment of the yet another assembly; and,

FIG. 8 shows a further position in an embodiment of the assembly method.

### DETAILED DESCRIPTION

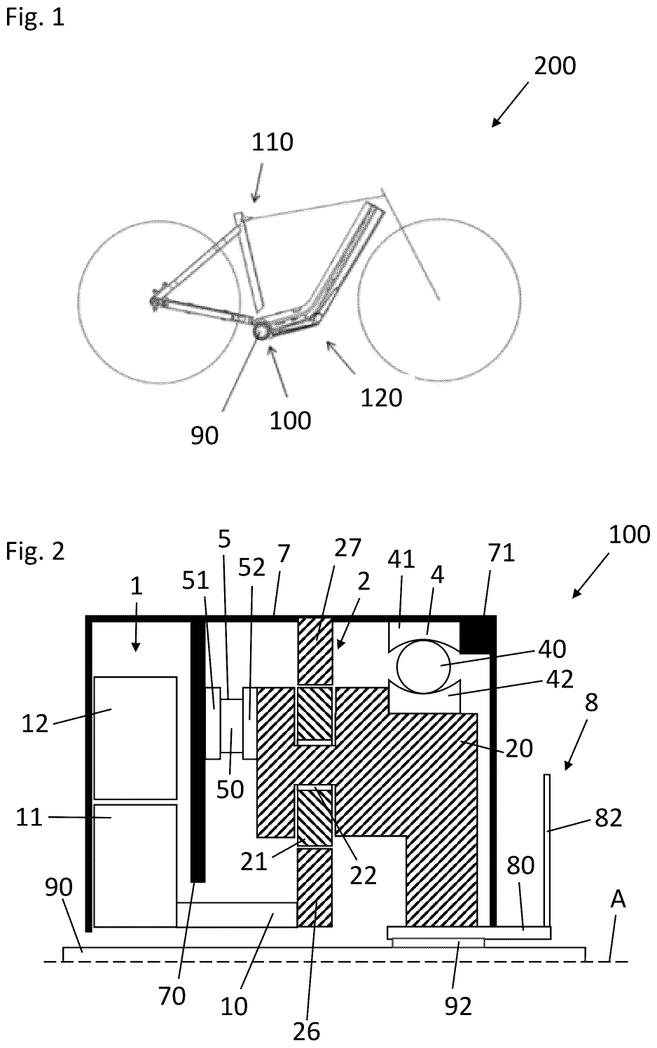

FIG. 1 schematically shows an electric bicycle 200 with a bicycle frame 110, which has a lower frame section 120. This forms a down tube. The lower frame section 120 extends toward a bottom bracket of the electric bicycle, wherein the bottom bracket includes a pedal shaft 90. The pedal shaft 90 is part of a drive device 100 installed in the bicycle.

FIG. 2 shows a first embodiment of the drive device 100 in a cross-sectional view. The drive device 100 has a planetary gearbox 2. The planetary gearbox 2 includes a planet carrier 20, which is mounted rotatably about a rotational axis A in a housing 7. One or more planet gears 21 are mounted on the planet carrier 20 rotatably with respect to the planet carrier 20. FIG. 2 shows only the part of the drive device 100 above the rotational axis A.

The planetary gearbox 2 also includes a sun gear 26. The at least one planet gear 21 is in meshed engagement with the sun gear 26, which is also mounted rotatably about the rotational axis A, for example. In addition, the at least one planet gear 21 is in meshed engagement with a ring gear 27 of the planetary gearbox 2. The ring gear 27 can be mounted rotatably about the rotational axis A or can be connected to the housing 7 in a rotationally fixed manner, that is, it can be mounted so as not to be rotatable.

The planetary gearbox 2 couples an electric motor 1 with an output 8. The electric motor 1 includes a rotor 11 and a stator 12. A motor shaft 10 of the electric motor 1 is connected to the sun gear 26 of the planetary gearbox 2 in a rotationally fixed manner. Alternatively, the motor shaft 10 can also be connected to the ring gear 27 or the planet carrier 20 in a rotationally fixed manner. The output 8 is connected in a rotationally fixed manner to the planet carrier 20. In particular, an output shaft 80 of the output 8, which is formed as a hollow shaft 80, is connected in a rotationally fixed manner to the planet carrier 20 and to a chainring 82 or a chainring spider 82.

The planetary gearbox 2 is used in the drive device 100 to transmit torque from the electric motor 1 to the output 8. With the aid of the planetary gearbox 2, the speed is reduced and the torque is increased in particular. The transmitted torque can be used to assist the pedaling motion of a rider of the electric bicycle. In this case, the pedal shaft 90, on which the rider manually applies torque, is coupled to the output shaft 80 via a freewheel 92, so that both the torque applied by the rider and the torque applied by the electric motor 1 can be transmitted to the output 8.

The rotary bearing of the planet carrier 20 in the housing 7 is realized with the aid of a radial bearing 4 and an axial bearing 5. The radial bearing 4 includes an inner ring 42, rolling elements 40, for example in the form of balls, and an outer ring 41. The outer ring 41 adjoins the housing 7 in the radial direction. In the axial direction, the outer ring 41 adjoins a support element 71 or is at least arranged directly opposite to it in the axial direction. The inner ring 42 adjoins the planet carrier 20 in the radial direction. In the axial direction, the inner ring 42 adjoins the planet carrier 20 or is at least arranged directly opposite to the planet carrier 20 in the axial direction.

A thrust washer 51 of the axial bearing 5, on which the rolling elements 50 of the axial bearing 5 roll, adjoins a support element 70 in the axial direction or is at least arranged directly opposite to the support element 70 in the axial direction. The support element 70 is also part of the housing 7. The rolling elements 50 of the axial bearing 5 can be cylinders or cones. The second thrust washer 52 of the axial bearing 5, on which the rolling elements 50 roll, adjoins the planet carrier 20 in the axial direction or is at least arranged directly opposite to the planet carrier 20.

The described arrangement keeps the tolerance chain for the radial and axial play of the planet carrier 20 low. For example, the axial play of the planet carrier 20 is at most 0.3 mm. This allows, for example, tilting of the planet carrier 20 within the housing to be kept low or avoided.

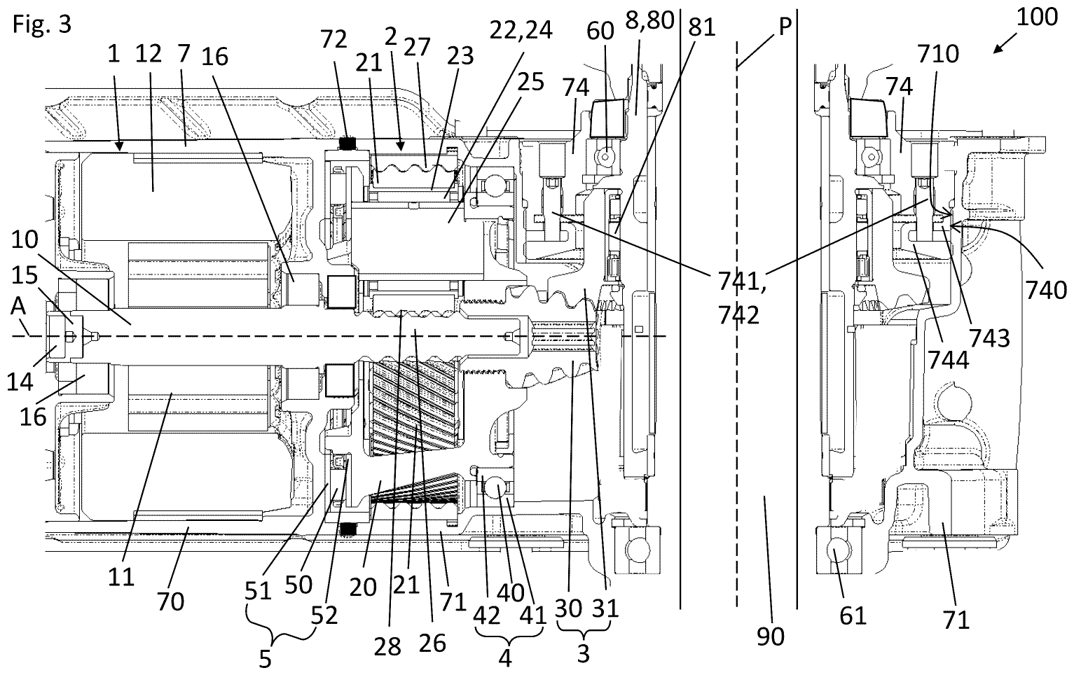

FIG. 3 shows a further embodiment of the drive device 100 in a cross-sectional view. The drive device 100 includes a housing 7 with three interconnected housing parts 70, 71, 74. The housing part 70 forms a motor housing in which an electric motor 1 is accommodated. The housing part 71 forms a bottom bracket housing in which, among other things, a planetary gearbox 2 is accommodated. The motor housing 70 and the bottom bracket housing 71 are connected to each other via a sealing sleeve 72. The housing part 74 forms an output-side cover that is screwed onto the bottom bracket housing 71.

The electric motor 1 includes a stator 12 and a rotor 11. The electric motor 1 is an internal rotor motor. During operation, the rotor 11 rotates relative to the stator 12 or the housing 7 about a rotational axis A. The rotor 11 is coupled to a motor shaft 10 and also causes it to rotate about the rotational axis A during operation. The rotational axis A runs through the motor shaft 10. The motor shaft 10 is made of stainless steel or case-hardened steel, for example. The electric motor 1 is mounted in the housing 7 via motor bearings 16.

The motor shaft 10 protrudes in an axial direction from the rotor 11 and into the planet carrier 20 of the planetary gearbox 2. In the opposite axial direction, a magnet 14 is arranged at the end of the motor shaft 10, which is spaced from the motor shaft 10 by an adapter 15. The adapter 15 is made of aluminum, for example, and is intended to reduce the influence of the steel motor shaft 10 on the magnetic field generated by the magnet 14. The drive device 100 further includes a sensor (not shown) which detects the magnetic field of the magnet 14 and thereby detects the position of the motor shaft 10 qualitatively and quantitatively.

The planetary gearbox 2, which forms a first gear stage of the drive device 100, includes the planet carrier 20, three planet gears 21, a sun gear 26, and a ring gear 27. FIG. 3 shows a first planet gear 21, namely the one above the rotational axis A, in cross-sectional view, whereas another planet gear 21 is shown in top view. The planet gears 21 are mounted on the planet carrier 20 so that they can rotate.

Similarly, the planet carrier 20 is mounted so as to be rotatable about the rotational axis A via two roller bearings 4, 5. In the present case, the planet carrier 20 has bushings 25 which are inserted through holes in the planet gears 21.

The sun gear 26 for the planetary gearbox 2 is here integrated in the motor shaft 10, that is the motor shaft 10 and the sun gear 26 are formed integrally or in one piece with each other. In particular, the toothing for the sun gear 26 is formed in the motor shaft 10 via a forming process, for example a rolling process. This means that the toothing for the sun gear 26 is produced without milling, which can be recognized by the absence of milling marks. The toothing of the sun gear 26 is a helical toothing, that is, the teeth do not run parallel to the rotational axis A but are skewed to or helical around the rotational axis A.

The toothing of the sun gear 26 meshes with respective helical toothing of the planet gears 21. Rotation of the motor shaft 10 causes the planet gears 21 to rotate, which in turn causes the planet carrier 20 to rotate about the rotational axis A. The planet gears 21 roll on the fixed ring gear 27. The ring gear 27 is fixed to the housing 7, for example, and therefore does not rotate relative to the housing 7 during operation.

The use of a forming process in the manufacture of the toothing of the sun gear 26 results in a particularly smooth tooth surface. The toothing of the planet gears 21 are made of plastic, for example. The smooth surface of the sun gear 26 is particularly advantageous when plastic is used for the planet gears 21, as this keeps their wear to a minimum. Planet gears made entirely or partially of plastic are more tolerant of manufacturing tolerances and are less sensitive to tilting relative to the planet carrier 20.

In fact, a tilting moment acts on the planet gears 21, which tends to tilt the planet gears 21 relative to the planet carrier 20. This tilting moment results largely from the use of helical teeth. However, the helical teeth are advantageous in terms of high power transmission and low noise generation.

In order to minimize tilting of the planet gears 21 relative to the planet carrier 20 and to counteract it as effectively as possible, the planet gears 21 are each mounted on the planet carrier 20 in a rotatable manner via a needle bearing 22. The needle-shaped or cylindrical rolling elements 24 of the needle bearing 22 roll on the bushings 25 on one side and on sleeves 23 on the other side. The bushings 25 and the sleeves 23 are made of metal, for example. The sleeves 23 are part of the planet gears 21 and are encased or overmolded with plastic, whereby the toothing of the planet gear 21 is formed from this plastic. By reducing the relative tilt between the planet gears 21 and the planet carrier 20 due to the use of the needle bearings 22, the wear of the drive device 100 can be reduced and its performance increased.

The planet carrier 20 has a recess at an axial end facing away from the motor 1. The rotational axis A runs through this recess. In the area of the recess, the planet carrier 20 has an internal thread. A first bevel gear 30, namely a bevel pinion, of a bevel gear stage 3 is screwed into this internal thread. The bevel gear stage 3 forms a second gear stage of the drive device 100. The first bevel gear 30 has a cylindrical section with an external thread and a conical section with external teeth. The cylindrical section is screwed into the recess of the planet carrier 23, whereby the first bevel gear 30 is fastened to the planet carrier 23 and is immovable relative to the planet carrier 20, that is, it is connected to the latter in a rotationally fixed manner. The first bevel gear 30 is precisely aligned relative to the planet carrier 20 with the aid of a centering collar. The conical section protrudes axially from the planet carrier 20 away from the electric motor 1.

The first bevel gear 30 has a recess that is open in the direction of the electric motor 1 and into which the motor shaft 10 is guided. The motor shaft 10 can rotate freely within this recess. Unlike depicted in FIG. 3, the motor shaft 10 could be rotatably mounted within the recess via a bearing.

The section of the motor shaft 10 protruding into the recess of the bevel gear 30 is free of the toothing. This section forms, for example, an interface for a so-called “stand-alone” test of the electric motor 1, that is, a test in an uninstalled state.

During operation, the planet carrier 20 and the first bevel gear 30 rotate together around the rotational axis A. The bevel gear stage 3 has a second bevel gear 31 in the form of a ring gear. The second bevel gear 31 is mounted so that it can rotate about a pedal axis P, with the pedal axis P running perpendicular to the rotational axis A. The bevel gear stage 3 is therefore a 90° bevel gear stage.

The second bevel gear 31 is coupled to an output shaft 80 in the form of a hollow shaft via a freewheel 81. The output shaft 80 is part of an output 8. The output 8 also includes, for example, a chainring and/or a chainring spider (not shown), which are connected to the output shaft 80 in a rotationally fixed manner. Alternatively, the output shaft 80 may also only have an interface for a rotationally fixed coupling with the chainring or the chainring spider.

A pedal shaft 90 extends through the hollow shaft-shaped output shaft 80. The pedal shaft 90 is coupled to the output shaft 80. The pedal shaft 90 and the output shaft 80 are rotatably mounted via radial bearings 60, 61, the so-called main bearings 60, 61. When the rider of the electric bicycle pedals, the pedal shaft 90 rotates around the pedal axle P and, via a freewheel, drives the output shaft 80. The electric motor 1 exerts a torque on the output shaft 80 via the planetary gearbox 2 and the bevel gear stage 3 to assist the rider. The drive device 100 shown is an orthogonal drive.

By using a bevel gear stage 3 coupled directly to the planet carrier 20, that is without any further intermediate gear stages, the drive device 100 can be configured to be particularly compact and at the same time provides efficient speed reduction from the electric motor 1 to the output 8. However, the direct coupling between the planet carrier 20 and the bevel gear stage 3 also results in the bevel gear stage 3 exerting an axial force, a radial force, and an azimuthal force on the planet carrier 20 during operation of the drive device 100. These forces attempt to push the planet carrier 20 toward electric motor 1 and simultaneously tilt the planet carrier 20.

In order to efficiently absorb the acting radial forces, the planet carrier 20 is mounted in the housing 7 via a large radial bearing 4. The radial bearing 4 has, for example, an inner diameter of 5 cm. The radial bearing 4 is supported by the planet carrier 20.

The axial forces that occur are absorbed by an axial bearing 5. In particular, the tilting moment that acts on the planet carrier 20 results in a large axial load on the axial bearing 5. The axial bearing 5 also has a large diameter. Here, the axial bearing 5 is arranged at the outer edge or outer circumference of the planet carrier 20, that is, radially spaced apart as far as possible from the rotational axis A. In addition, elongated rolling elements, for example cylinders or cones, are used as rolling elements 50 of the axial bearing 5, whereby the load is distributed over a larger area.

In order to minimize tilting of the planet carrier 20, the axial clearance for the planet carrier 20 between the radial bearing 4 and the axial bearing 5 is kept particularly small, for example, a maximum of 0.1 mm. Among other things, this is achieved by a small tolerance chain in the axial direction. The small tolerance chain is implemented as follows: A thrust washer 51 of the axial bearing 5, on which the rolling elements 52 roll, is arranged in the axial direction directly opposite a support element, namely a radially extending part of the motor housing 70. The other thrust washer 52 of the axial bearing 5 is arranged in the axial direction directly opposite the planet carrier 20. Furthermore, the inner ring 42 of the radial bearing 4, on which the rolling elements 40 of the radial bearing 4 roll, is arranged in the axial direction directly opposite the planet carrier 20, and the outer ring 41 of the radial bearing 4 is arranged in the axial direction directly opposite a further support element, namely a part of the bottom bracket housing 71. The motor housing 70 and the bottom bracket housing 71 are connected to each other in an axially immovable manner. The elements directly opposite each other in the axial direction either adjoin each other, or spaced apart from each other at most by narrow gaps in the axial direction. In particular, the sum of the axial distances between the aforementioned directly opposite elements is less than 0.1 mm.

When the drive device 100 is installed and the motor is running, the planet carrier 20 is pressed axially toward the electric motor 1. The planet carrier 20 then abuts axially directly on the thrust washer 52, and the thrust washer 51 abuts axially directly on the motor housing 70. The small axial distances mentioned above ensure that the planet carrier 20 hardly tilts at all despite the strong tilting moment.

Another measure to reduce the tilting of the planet carrier 20 is a small radial clearance for the planet carrier 20 and the first bevel gear 30. For this purpose, the first bevel gear 30 is firmly connected to the planet carrier 20. The play of the planet carrier 20 in the radial direction is kept low by the fact that the radial bearing 4 used for the radial mounting of the planet carrier 20, which is arranged radially between the planet carrier 20 and the housing 7, abuts the planet carrier 20 with its inner ring 42 and the housing 7 with its outer ring 41 in the radial direction. No intermediate elements are used between the radial bearing 4 and the housing 7, as these could increase the play of the planet carrier 20 or the first bevel gear 30 in the radial direction. In other words, by using fewer elements in the radial tolerance chain, the radial clearance of the first bevel gear 30 and the planet carrier 20 is kept low. This means that the planet carrier 20 can only tilt to a limited extent.

Overall, the use of the radial bearing 4 and the axial bearing 5 described above helps to counteract tilting of the planet carrier 20 and to absorb the acting forces efficiently. This makes the drive device 100 particularly powerful while at the same time ensuring low wear.

Performance is further enhanced by the precise alignment of the bevel gears 30, 31 with each other. This is achieved on the one hand by the low-clearance mounting of the planet carrier 20 and the first bevel gear 30 described above, and on the other hand by a low-clearance mounting of the second bevel gear 31. For this purpose, the second bevel gear 31 is connected to the output shaft 80 in a fixed, that is, immovable, manner. The output shaft 80, in turn, is mounted via the radial bearing 60 so that it can rotate about the rotational axis P, with the radial bearing 60 being in direct contact with the output shaft 80 on the one hand and in direct contact with the cover 74 on the other. The cover 74, in turn, is firmly connected to the bottom bracket housing 71. Here too, in order to reduce the clearance of the second bevel gear 31 in the axial direction, parallel to the rotational axis A, a rotatable mounting of the second bevel gear 31 around the rotational axis P is realized with few movable elements between the housing 7 and the second bevel gear 31.

The fixed connection between the housing parts 71, 74 is a screw connection. For this screw connection, the bottom bracket housing 71 and the cover 74 have threads 710, 740 that interlock.

These threads 710, 740 extend around the rotational axis P of the pedal shaft 90. The relative arrangement between the housing parts 71 and 74 is secured via fixing elements 742. The fixing elements 742 are screws in this case, which are screwed into receptacles 741 of the housing part 74. Specifically, the housing part 74 has two ring-shaped sections 743, 744, which are, in the shown cross-sectional view, by a U-shaped area of the third housing part 74, that is, they are spaced apart from each other by a gap in the direction parallel to the rotational axis P. The two sections 743, 744 each form part of the external thread 740 of the housing part 74. Longitudinal ends of the screwed-in screws 742 press the second section 744 away from the first section 743, causing the screw connection between the housing parts 71, 74 to jam and thus fixing them in their relative arrangement to each other.

The second bevel gear 31 is restricted in its movement relative to the third housing element 74 in a direction parallel to the rotational axis P via stop surfaces. The screw connection between the housing parts 71, 74 therefore allows the second bevel gear 31 to be positioned particularly accurately along the rotational axis P. The fixing of the screw connection then ensures a particularly stable position of the second bevel gear 31 in the direction of the rotational axis P. Overall, the bevel gears 30, 31 are then aligned with each other with particular precision, which benefits the performance of the entire drive device 100.

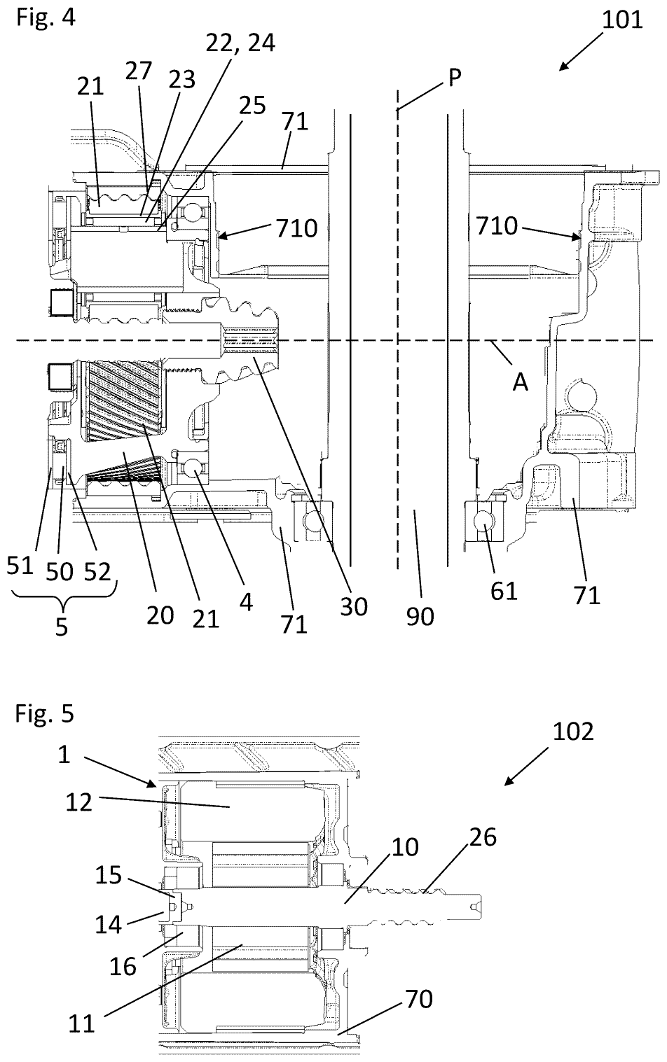

FIG. 4 shows an embodiment of the assembly 101 for the drive device of FIG. 3. The assembly 101 includes the bottom bracket housing 71 as well as the planet carrier 20 and the first bevel gear 30, which are coupled to each other in a rotationally fixed manner and are mounted rotatably via the radial bearing 4 carried by the planet carrier 20. The assembly 101 also includes the planet gears 21, which are rotatably mounted on the planet carrier 20 via the needle bearings 22. The axial bearing 5 is arranged on the side of the planet carrier 20 facing away from the first bevel gear 30. In addition, the pedal shaft 90 is inserted through the bottom bracket housing 71. The bottom bracket housing 71 is made of metal, for example. The bottom bracket housing 71 is formed in one piece and encloses both the pedal shaft 90 in the direction around the pedal axis P and the planet carrier 20 in the direction around the rotational axis A.

FIG. 5 shows an embodiment of the further assembly 102 for the drive device 100 of FIG. 3. The assembly 102 includes the motor housing 70, in which the electric motor 1 with the associated motor shaft 10 is accommodated.

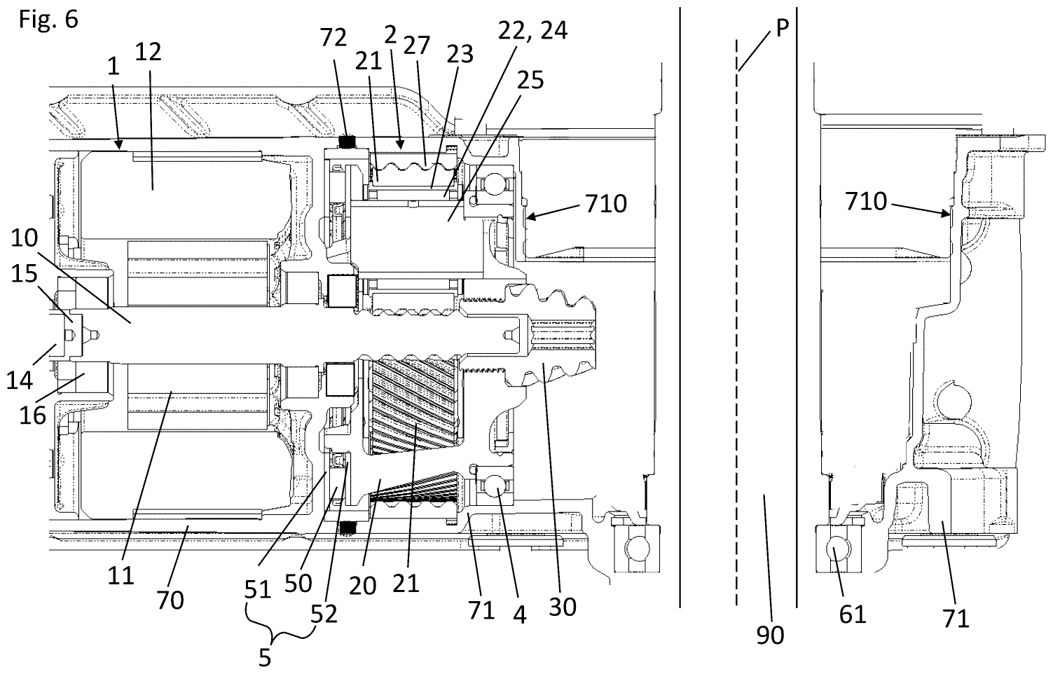

To assemble the drive device 200 of FIG. 3, the assembly 102 is first connected to the assembly 101. The resulting device is shown in FIG. 6. During assembly, the motor shaft 10 is pushed through the planet carrier 20 into the receptacle of the first bevel gear 30. In addition, the thrust washer 51 is arranged axially directly opposite a radially extending section of the motor housing 70. The housing parts 70, 71 are connected to each other. The dimensions of the individual elements are selected so that there are no or only small air gaps in the axial direction between the housing sections, on which the bearings 4, 5 can be axially supported.

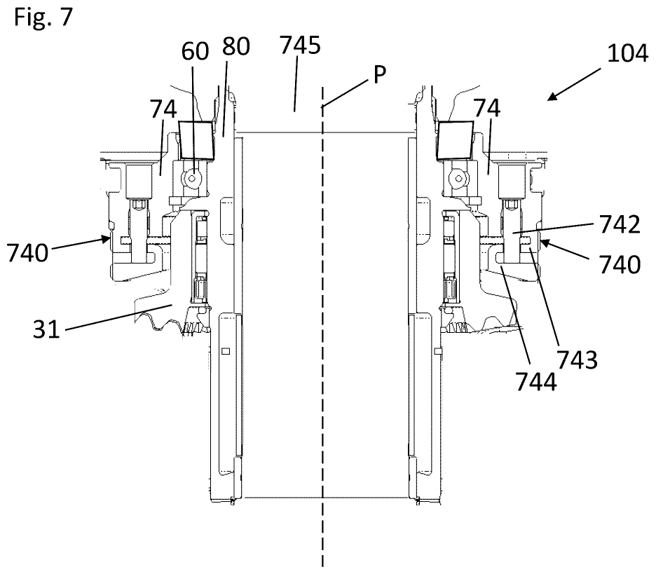

FIG. 7 shows an embodiment of the yet another assembly 104 for assembling the drive device 100 of FIG. 3. Assembly 104 includes housing part 74. The fixing elements 742 in the form of screws have already been inserted into the receptacles 741 of housing part 74, but only to the extent that sections 743, 744 are not yet clamped with respect to each other. The assembly 104 also includes the bevel gear 31, the output shaft 80, and the radial bearing 60. The bevel gear 31 and the output shaft 80 are rotatably mounted via the radial bearing 60.

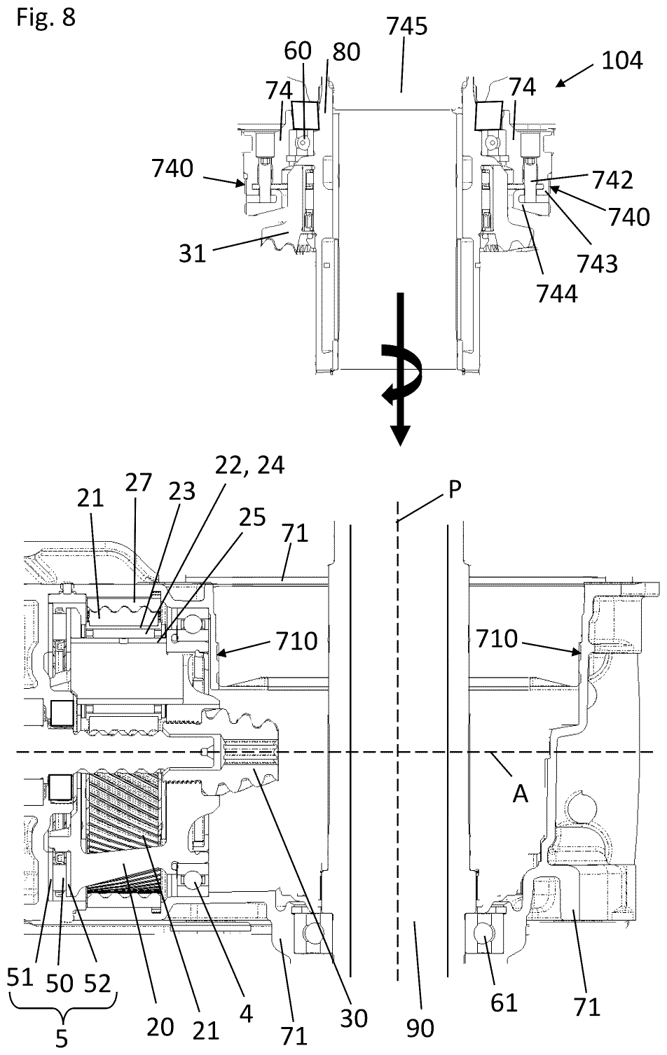

To assemble the drive device, the assembly 104 shown in FIG. 7 is now screwed onto the device shown in FIG. 6 (see FIG. 8). The pedal shaft 90 is pushed through the feedthrough 745 in the housing part 74. The housing parts 74, 71 are screwed together until the positioning of the bevel gears 30, 31 in a direction parallel to the rotational axis P is adjusted as desired. The screws 742 are then tightened, clamping the sections 743, 744 with respect to each other and thereby clamping the screw connection between the housing part 74 and the housing part 71. This allows the bevel gears 30, 31 to be fixed in their relative position parallel to the rotational axis P.

It is understood that the foregoing description is that of the preferred embodiments of the invention and that various changes and modifications may be made thereto without departing from the spirit and scope of the invention as defined in the appended claims.

### LIST OF REFERENCE SIGNS

1 electric motor
2 planetary gearbox
3 bevel gear stage
4 radial bearing
5 axial bearing
7 housing
8 output
10 motor shaft
11 rotor
12 stator
14 Magnet
15 adapter for magnet
16 motor bearing
20 planet carrier
21 planet gear
22 needle bearing
23 outer sleeve
24 rolling element
25 bushing/bolt
26 sun gear
27 ring gear
30 first bevel gear/bevel pinion
31 second bevel gear/ring gear
40 rolling element
41 outer ring
42 inner ring
50 rolling element
51 thrust washer
52 thrust washer
60 radial bearing
61 radial bearing
70 motor housing
71 bottom bracket housing
72 sealing sleeve
74 cover
80 output shaft
81 freewheel
82 chainring/chainring spider
90 pedal shaft
92 freewheel
100 drive device
101 assembly
102 assembly
104 assembly
110 bicycle frame
120 down tube
200 electric bicycle
710 thread
740 thread
741 receptacle
742 fixing element/screw
743 first section
744 second section
745 feedthrough
A rotational axis
P pedal axle/rotational axis

1. A drive device for an electric bicycle, the drive device comprising:
a planetary gearbox with a planet carrier; and,
said planet carrier being mounted rotatably about a rotational axis via a radial bearing and an axial bearing.

2. The drive device of claim 1, wherein said axial bearing includes elongated rolling elements.

3. The drive device of claim 1, wherein said axial bearing is arranged in a radial direction at an outer edge of said planet carrier.

4. The drive device of claim 1, wherein an axial clearance of said planet carrier in the drive device is at most 0.3 millimeters.

5. The drive device of claim 1, wherein:
a thrust washer of said axial bearing is directly opposite a support element of the drive device in an axial direction;
a further thrust washer of said axial bearing is directly opposite said planet carrier in the axial direction;
a ring of said radial bearing is directly opposite a further support element of the drive device in the axial direction; and,
a further ring of said radial bearing is directly opposite said planet carrier in the axial direction.

6. The drive device of claim 1, wherein said radial bearing is coupled both directly to said planet carrier and directly to a housing of the drive device.

7. The drive device of claim 1 further comprising:
a planet gear rotatably mounted on said planet carrier; and,
said planet gear being arranged axially between said axial bearing and said radial bearing.

8. The drive device of claim 1, wherein an inner diameter of said radial bearing is larger than an inner diameter of said axial bearing.

9. The drive device of claim 1 further comprising:
an electric motor;
an output; and,
said electric motor being coupled to said output via said planetary gearbox in order to transmit torque from said electric motor to said output.

10. The drive device of claim 9 further comprising:
a bevel gear stage between said planetary gearbox and said output; and,
said bevel gear stage being coupled to said planetary gearbox without an intermediate gear stage.

11. The drive device of claim 10, wherein said radial bearing is arranged axially between said axial bearing and a second bevel gear of said bevel gear stage.

12. The drive device of claim 10, wherein said bevel gear stage includes a second bevel gear and a first bevel gear; and, a support width of said axial bearing is greater than an axial distance of said radial bearing to an interface of said first bevel gear and said second bevel gear of said bevel gear stage.

13. The drive device of claim 11, wherein said bevel gear stage includes said second bevel gear and a first bevel gear; and, a support width of said axial bearing is greater than an axial distance of said radial bearing to an interface of said first bevel gear and said second bevel gear of said bevel gear stage.

14. The drive device of claim 10, wherein said planet carrier is coupled to a first bevel gear of said bevel gear stage in a rotationally fixed manner.

15. The drive device of claim 14, wherein said bevel gear stage includes said first bevel gear and a second bevel gear; and, said second bevel gear engaging with said first bevel gear is coupled to said output without an intermediate gear stage.

16. An assembly for a drive device of an electric bicycle, the assembly comprising:
a planet carrier for a planetary gearbox; and,
a radial bearing and an axial bearing for mounting said planet carrier rotatably about a rotational axis.
